(19) United States
(12) Patent Application Publication
(10) Pub. No.: US 2006/0226217 A1
(43) Pub. Date: Oct. 12, 2006

(54) Sleeve for electronic transaction card

(75) Inventors: Siva G. Narendra, Portland, OR (US); Prabhakar Tadepalli, Bangalore (IN); Thomas N. Spitzer, Portland, OR (US)

Correspondence Address: LeMoine Patent Services, PLLC;c/o PortfolioIP, P.O. Box 52050, Minneapolis, MN, 55402, US

(73) Assignee: Tyfone, Inc.

(21) Appl. No.: 11/100,645

(22) Filed: Apr. 7, 2005

(51) Int. Cl. G06K 5/00; G06K 15/00

(52) U.S. Cl. 235/380; 235/383

(57) ABSTRACT

A sleeve provides communications between an electronic transaction card and an intelligent electronic device. The intelligent electronic device may be a mobile phone or other device with or without network connectivity. The electronic transaction card may have magnetic field producing circuitry compatible with magnetic card readers, smartcard circuitry, other point-of-sale interfaces, or any combination thereof.

### FIELD

The present invention relates generally to electronic devices, and more specifically to electronic devices that may perform transactions.

### BACKGROUND

Magnetic cards have many purposes. Examples include credit cards, debit cards, stored value cards, identification cards, access entry cards, and the like. Many of these cards have information stored in a magnetic stripe in a static manner. For example, a credit card may have a credit card number, a cardholder's name, and an issuing bank's name statically encoded in a magnetic strip. Likewise, an identification card or access entry card may have statically encoded information that identifies an individual or allows access to a controlled access area. When the card is swiped through a magnetic card reader, the information is transferred to the magnetic card reader to perform a transaction, such as a financial transaction or identification transaction.

### BRIEF DESCRIPTION OF THE DRAWINGS

FIGS. 1-4 show exploded views of an intelligent electronic device, a sleeve, and an electronic transaction card;

FIG. 5 shows an intelligent electronic device, a sleeve, and an electronic transaction card;

FIG. 6 shows an electronic transaction card and a card reader;

FIG. 7 shows an intelligent electronic device, a sleeve an electronic transaction card, and a magnetic card reader;

FIG. 8 show a sleeve for use with an electronic transaction card;

FIGS. 9-11 show block diagrams of sleeves;

FIGS. 12 and 13 show a foldable electronic transaction card;

FIGS. 14 and 15 show an electronic transaction card having a sliding portion;

FIG. 16 shows an intelligent electronic device and an electronic transaction card; and

FIGS. 17 and 18 show block diagrams of electronic transaction cards.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

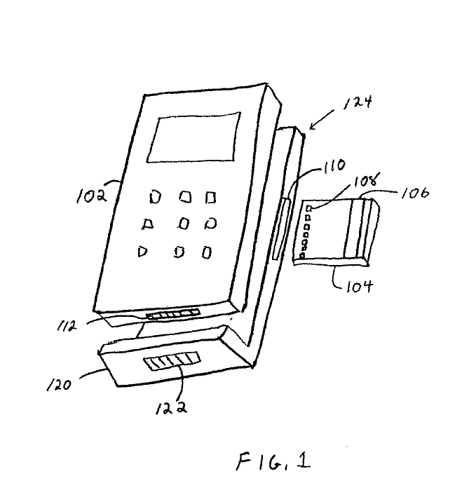

FIG. 1 shows an intelligent electronic device, a sleeve and an electronic transaction card. Intelligent electronic device 102 includes connector 112; sleeve 120 includes body portion 124, replicated connector 122, and add-on slot 110; and electronic transaction card 104 includes electrical contacts 108 and stripe 106.

Intelligent electronic device 102 is shown as a mobile phone in FIG. 1, but this is not a limitation of the present invention. For example, intelligent electronic device 102 may be a personal digital assistant (PDA), a smartphone, a mobile phone, a handheld computer, or any other device capable of operating as described herein.

Intelligent electronic device 102 may include a mechanism to allow intelligent electronic device 102 to communicate with a! wired or wireless network. S For example, intelligent electronic device 102 may include circuitry to communicate with a cellular phone network. Note that in these embodiments, intelligent electronic device 102 may or may not be a phone. For example, intelligent electronic device 102 may be a cellular telephone with an add-on slot for use with an electronic transaction card. Also for example, intelligent electronic device may be a non-telephonic device that has cellular network connectivity. Examples include personal digital assistants, and handheld devices dedicated to the use of electronic transaction cards. Further, intelligent electronic device 102 may be a non-telephonic device having wired or wireless connectivity to a network other than a cellular network, and in some embodiments, intelligent electronic device 102 may be a device without network connectivity. Examples include, but are not limited to: Blackberry devices available from Research in Motion (RIM), music players such as MP3 players, cameras, and the like.

Intelligent electronic device 102 includes connector 112. Connector 112 may be a data connector that allows intelligent electronic device 102 to communicate with other devices. For example, connector 112 may be a data connector on the base of a cellular phone or PDA that can communicate with a cradle to synchronize the cellular phone or PDA with another data repository such as a computer. Although connector 112 is shown at the base of intelligent electronic device 102, this is not a limitation of the present invention. For example, connector 112 may be on a side, back, top, or any other surface of intelligent electronic device 102.

Sleeve 120 is a sleeve that mechanically and electrically mates with intelligent electronic device 102. In some embodiments, sleeve 120 includes a mating connector (not shown) that electrically mates with connector 112 when intelligent electronic device 102 is coupled to sleeve 120. Sleeve 120 may also include replicated connector 122. Replicated connector 122 replicates connector 112 to allow intelligent electronic device 102 to communicate with other devices while mated with sleeve 120. In some embodiments, intelligent electronic device 102 and sleeve 120 communicate wirelessly. For example, intelligent electronic device 102 and sleeve 120 may communicate using a personal area network (PAN) such as Bluetooth, a wireless area network (WAN) such as IEEE 802.11, or any other wireless communications protocol. In these embodiments, replicated connector 122 may replicate connector 112 using wireless communications between intelligent electronic device 102 and sleeve 120.

Sleeve 120 has a body portion 124 that includes a contour to mechanically accept intelligent electronic device 102. For simplicity, sleeve 120 is shown having a contour that is relatively flat to accept intelligent electronic device 102, which is also shown as relatively flat. In other embodiments, sleeve 120 has a contour that is not flat. For example, sleeve 120 may have a concave or convex contour to match the shape of a mating intelligent electronic device. Further, in some embodiments, the body of sleeve 120 may have sides that more fully envelope intelligent electronic device 102.

Sleeve 120 includes add-on slot 110. Add-on slot 110 is a slot capable of accepting electronic transaction card 104. For example, add-on slot 110 may have physical dimensions compatible with electronic transaction card 104, and may have a communications interface that operates using a protocol compatible with electronic transaction card 104. In some embodiments, electronic transaction card 104 includes an identification number that provides a relationship to sleeve 120 or intelligent electronic device 102. For example, electronic transaction card 104 may include an ID number that provides a unique pairing relationship or a non-unique pairing relationship between electronic transaction card 104 and intelligent electronic device 102, or between electronic transaction card 104 and sleeve 120, or between electronic transaction card 104 and both sleeve 120 and intelligent electronic device 102.

In some embodiments of the present invention, add-on slot 110 is a memory card slot designed to accept and communicate with memory cards. Add-on slot 110 slot may be a proprietary card slot designed to accept memory cards that adhere to a proprietary communications protocol. Add-on slot 110 may also be compatible with an industry standard communications protocol, or may be compatible with a widely accepted communications protocol that is not necessarily formally documented as an industry standard. Examples include slots that are compatible with the Multimedia Memory Card (MMC) protocol, Memory Stick DUO protocol, secure digital (SD) protocol, and Smart Media protocol. The foregoing list is meant to be exemplary, and not exhaustive. Add-on slot 110 may be compatible with many memory card slot protocols other than those explicitly listed above without departing from the scope of the invention.

In some embodiments of the present invention, add-on slot 1 10 is compatible with electronic transaction cards that are substantially the same size as a credit card. In these embodiments, an electronic transaction card may have a width and a length, and add-on slot 1 10 may accept an edge of the card that has a dimension equal to either the width or the length. Further, in some embodiments, add-on slot may be compatible with a folded electronic transaction card, embodiments of which are described further below.

Electronic transaction card 104 includes electrical contacts 108 and stripe 106. Electrical contacts 108 are contacts that provide a communications interface to communicate with add-on slot 110. For example, electrical contacts 108 may provide connectivity compliant with a communications protocol for memory cards. Also for example, electrical contacts 108 may provide connectivity that is not compliant with a communications protocol for memory cards. The electrical contacts may be on the back side of electronic transaction card 104, recessed on an edge of electronic transaction card 104, or on the front side of electronic transaction card 104. In some embodiments, electronic transaction card 104 includes a “contactless” interface to add-on slot 110. For example, electronic transaction card 104 may include an interface to add-on slot 110 that communicates using electric or magnetic fields, infrared (IR) light, or any other suitable communications mechanism.

Stripe 106 represents an area on an external face of electronic transaction card 104 at which one ore more time-varying magnetic fields emanate. For example, one or more time-varying magnetic fields may emanate from the location of stripe 106 to communicate with a magnetic card reader. In some embodiments, the time-varying magnetic field may emulate the time-varying magnetic field produced when a typical magnetic card is swiped through a magnetic card reader. For example, a time-varying magnetic field produced at stripe 106 may emulate the swipe of a credit card, a debit card, or any other card having a magnetic stripe compatible with a magnetic card reader.

In some embodiments of the present invention, stripe 106 may be a visible stripe on electronic transaction card 104. When stripe 106 is visible, it may be used to indicate the location at which the time-varying magnetic field will emanate. In other embodiments of the present invention, stripe 106 may not be visible. For example, circuitry may be included within electronic transaction card 106 to produce the time-varying magnetic field and no visible indication may be present on an external face of electronic transaction card 104.

Stripes may be compatible with one or more standards. A stripe may be compatible with a standard by being in compliance with the standard or by being partially in compliance with the standard. For example, stripe 106 may be compatible with an American National Standards Institute (ANSI) magnetic stripe standard, or an International Organization for Standardization (ISO) magnetic stripe standard. In addition, in some embodiments, a stripe may emulate more than one magnetic track, and the emulated tracks may or may not be offset from the location specified in a standard. For example, one or more wires may be utilized to generate time-varying magnetic fields compatible with a standard, and the wires may be located at or near stripe 106 in a location different than the magnetic track offset described in an associated standard.

In operation, intelligent electronic device 102 may communicate with electronic transaction card 104 through sleeve 120, and also may program electronic transaction card 104 for use in a transaction involving stripe 106. For example, intelligent electronic device 102 may program electronic transaction card 104 to operate as a credit card, a debit card, or the like. Electronic transaction card 104 may then be used with a magnetic stripe or smartcard based merchant point-of-sale terminal to effect a transaction. Also for example, intelligent electronic device 102 may program electronic transaction card 104 to operate in any other environment where stripe 106 may be beneficially utilized with a magnetic card reader. In some embodiments, communications over a network may play a role in the transaction. For example, intelligent electronic device 102 may receive authorization for the transaction over a network. Also for example, intelligent electronic device 102 may program electronic transaction card 104 to perform a transaction, and then report the transaction to an entity using the network.

Electronic transaction card 104 may be utilized in financial transactions. For example, electronic transaction card 104 may be programmed to operate as a credit card or a stored value card. In these embodiments, electronic transaction card 104 may be programmed to emit one or more time-varying magnetic fields to emulate the swiping of a credit card or stored value card. In some of these embodiments, electronic transaction card 104 may use one number repeatedly, or may use a different number for each transaction. For example, electronic transaction card 104 may be programmed to have one number, similar to how a credit card uses the same number repeatedly. Also for example, electronic transaction card 104 may be programmed to use a different number for each transaction. These numbers are referred to herein as “single transaction account numbers” or “STANs.”

Single transaction account numbers may be generated by the card issuer or locally by either an intelligent electronic device or an electronic transaction card. Generation of STANs may be accomplished in any of several ways. For example, when an electronic transaction card is issued, the cardholder may receive several pre-assigned single-use transaction numbers. The numbers may also have a pre-specified sequence. In some embodiments, this sequence may be known only to the issuing bank and the cardholder's intelligent electronic device and/or electronic transaction card. A card issuing bank may authorize payments based on the expected sequence of account numbers, and if out-of-sequence account numbers are used, then the issuing bank may consider that transaction as a potentially fraudulent transaction. The issuing bank may also use this feature to track the merchant involved in the potentially fraudulent transaction.

According to another example, a pre-assigned sequence of STANs may be reset to the original starting number on the list depending on user input or other triggers. In addition, the list of numbers may be periodically downloaded via a cellular phone network or other network connectivity.

FIG. 2 shows an exploded view of an intelligent electronic device, a sleeve, and an electronic transaction card. Intelligent electronic device 202 is similar to intelligent electronic device 102 (FIG. 1), with the exception of connector 212. Further, sleeve 220 is similar to sleeve 120 (FIG. 1), with the exception of mating connector 222.

Intelligent electronic device 202 includes connector 212 which is in the form of an add-on slot that receives mating connector 222 of sleeve 220. In some embodiments, connector 212 is a memory card slot as described above with reference to add-on slot 110 (FIG. 1). In other embodiments, connector 212 is a slot other than a memory card slot.

Mating connector 222 of sleeve 220 includes contacts 224 to communicate with intelligent electronic device 202. In some embodiments, connector 222 is compatible with a memory card interface, and is received by a memory card compatible add-on slot shown as connector 212.

Add-on slot 210 may or may not be a replicated connector. For example, in embodiments where both connector 212 and add-on slot 210 are memory card slots, add-on slot 210 may replicate connector 212. In these embodiments, sleeve 220 may provide general memory card connectivity for intelligent electronic device 202. Further, in some embodiments, sleeve 220 includes multiple replicated connectors. For example, add-on slot 210 may be one of two or more add-on slots that provide connectivity for an electronic transaction card as well as other peripheral devices.

Electronic transaction card 204 includes electrical contacts 208 and 206. Electrical contacts 208 are similar to electrical contacts 108 (FIG. 1). For example, electrical contacts 208 are compatible with add-on slot 210 of sleeve 220. Electrical contacts 206 are arranged to provide the communications interface to a smartcard reader.

In some embodiments, electronic transaction card 204 includes a smartcard interface as well as a stripe to produce one or more time-varying magnetic fields. For example, the backside of electronic transaction card 204 may include a stripe. Any of the various electronic transaction cards described herein may include a stripe, a smartcard interface, or a combination thereof.

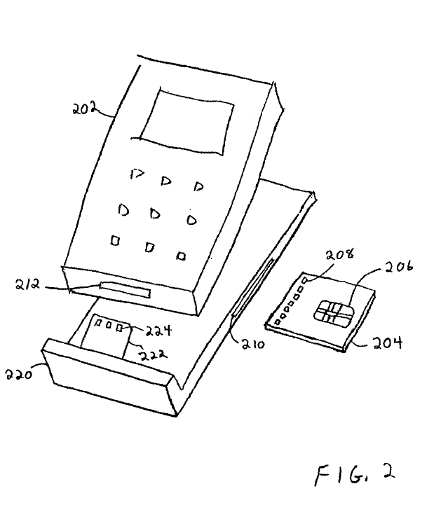

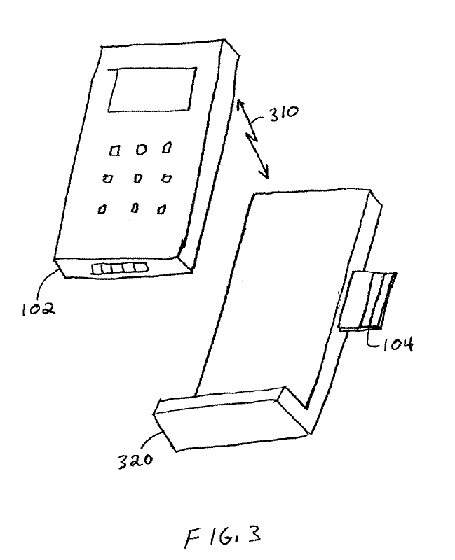

FIG. 3 shows an intelligent electronic device, a sleeve and an electronic transaction card. Intelligent electronic device 102 is described above with reference to FIG. 1. As shown in FIG. 3, intelligent electronic device 102 communicates with sleeve 320 over a wireless link 310. Wireless link 310 may be any type of wireless link, including a personal area network (PAN) such as Bluetooth. Sleeve 320 is shown having electronic transaction card 104 inserted into an add-on slot. Sleeve 320 may also have a replicated connector (not shown).

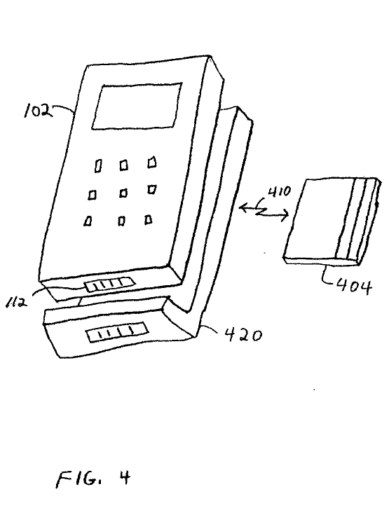

FIG. 4 shows an intelligent electronic device, a sleeve and an electronic transaction card. As in the embodiments represented by FIG. 1, intelligent electronic device 102 mates to sleeve 420 using connector 112. Sleeve 420 communicates with electronic transaction card 404 using wireless link 410. Wireless link 410 may be any type of wireless link, including a personal area network (PAN) such as Bluetooth. In embodiments represented by FIG. 4, sleeve 420 and electronic transaction card 404 both include wireless interfaces.

FIG. 5 shows an intelligent electronic device, a sleeve, and an electronic transaction card. Intelligent electronic device 502 may be any intelligent electronic device described herein. For example, intelligent electronic device 502 may include a connector or a wireless interface to communicate with sleeve 520. Sleeve 520 may be any sleeve described herein. For example, sleeve 520 may include a mating connector or a wireless interface to communicate with intelligent electronic device 502. Further, sleeve 520 may include a replicated connector. The replicated connector may be connector 522 or may be add-on slot 510 into which electronic transaction card 504 is shown inserted.

Electronic transaction card 504 is shown protruding from sleeve 520, but this is not a limitation of the present invention. For example, in some embodiments, electronic transaction card 504 is flush with sleeve 520 when inserted. Further, in some embodiments, electronic transaction card 504 is recessed within sleeve 520 when inserted.

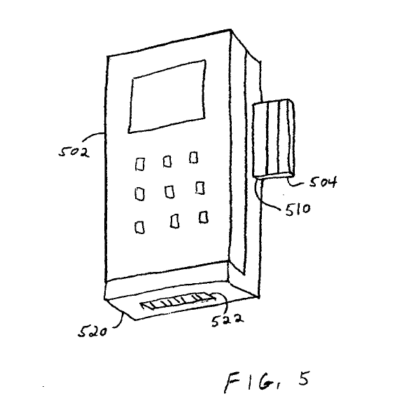

FIG. 6 shows an electronic transaction card and a card reader. Electronic transaction card 610 is a card having a stripe compatible with a magnetic card reader. For example, electronic transaction card 610 may be electronic transaction card 104 (FIG. 1), electronic transaction card 204 (FIG. 2), electronic transaction card 404 (FIG. 4), electronic transaction card 504 (FIG. 5), or any other electronic transaction card described herein. Magnetic card reader 620 is a card reader compatible with magnetic cards. For example, magnetic card reader 620 may operate as part of a merchant point-of-sale terminal, an access control device, or the like. When a magnetic card is swiped through magnetic card reader 620, one or more time-varying magnetic fields are produced relative to the location of a magnetic read head (not shown) in magnetic card reader 620.

In the operation depicted in FIG. 6, electronic transaction card 610 is swiped through magnetic card reader 620. During the swiping operation, electronic transaction card 610 produces one or more time-varying magnetic fields to emulate the swiping of a magnetic card. For example, a swipe sensor within electronic transaction card 610 may detect the swiping action depicted in FIG. 6, and a magnetic field producing circuit may generate one or more time-varying magnetic fields as electronic transaction card 610 passes by a magnetic read head in magnetic card reader 620.

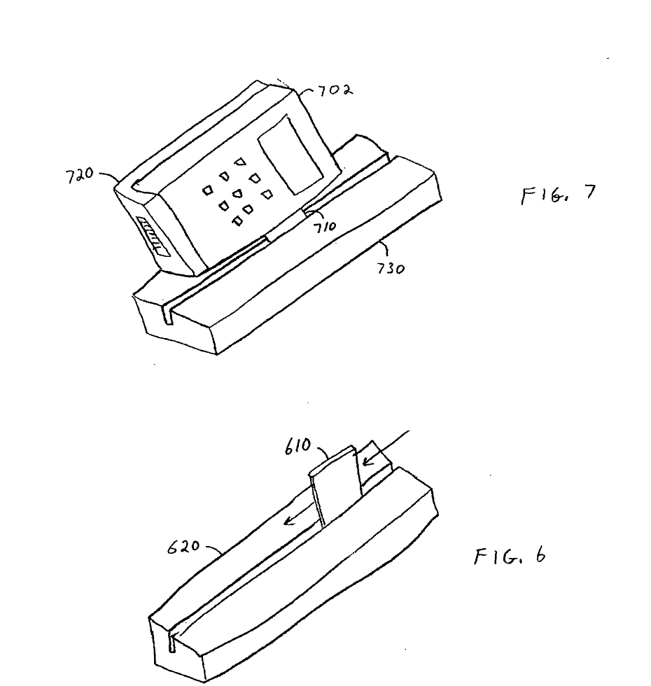

FIG. 7 shows an intelligent electronic device, a sleeve an electronic transaction card, and a magnetic card reader. Electronic transaction card 710 is shown being swiped through magnetic card reader 730 while attached to sleeve 720. Further, intelligent electronic device 702 is shown mated with sleeve 720. The operation depicted in FIG. 7 represents a transaction occurring while electronic transaction card 710 is coupled to an add-on slot of sleeve 720.

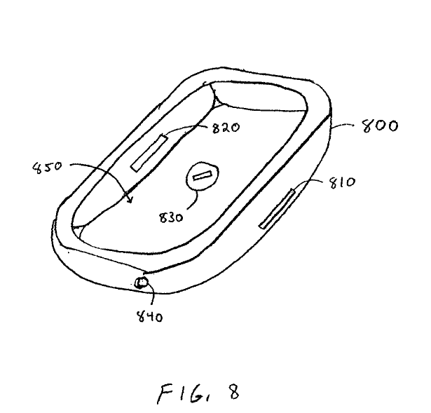

FIG. 8 show a sleeve for use with an electronic transaction card. Sleeve 800 includes a body with contour 850 to receive an intelligent electronic device. Sleeve 800 also includes mating connector 820 to communicate with an intelligent electronic device, and an add-on slot 810 to receive an electronic transaction card. Sleeve 800 also includes battery 830 and charger port 840.

In operation, an intelligent electronic device may be mechanically mated with contour 850, and may be electrically mated with mating connector 820. Add-on slot 810 provides communications with an electronic transaction card, and may also be a replicated connector as described above. Battery 830 provides power to electronics within sleeve 800, and charger port 840 is compatible with a charger to allow sleeve 800 to be “plugged in” to charge battery 830.

The particular mechanical configuration of sleeve 800 is not a limitation of the present invention. For example, battery 830 may be located differently or may be a different shape. Further, mating connector 820 may be located differently or may be a different shape.

FIG. 9 shows a block diagram of a sleeve. Sleeve 900 includes mating connector 910, intelligent electronic device (IED) interface 920, replicated connector 930, data routing circuitry 940, electronic transaction card interface 950, add-on slot 960, and power source 970. Sleeve 800 may include more than shown in FIG. 9, and nothing in FIG. 9 is to be considered essential to a sleeve as described herein.

Mating connector 910 provides an electrical connection to a connector on an intelligent electronic device. For example, mating connector 910 may be a connector to mate with connector 112 (FIG. 1), connector 212 (FIG. 2), 820 (FIG. 8), or any other intelligent electronic device connector. Replicated connector 930 provides a connector on sleeve 900 to replicate the connector on the intelligent electronic device that mates with mating connector 910. IED interface 920 provides a compatible interface protocol for sleeve 900 to communicate through mating connector 910 and replicated connector 930.

Add-on slot 960 is a slot compatible with an electronic transaction card. For example, add-on slot 960 may be a slot such as add-on slot 110 (FIG. 1), add-on slot 210 (FIG. 2), add-on slot 510 (FIG. 5), or add-on slot 810 (FIG. 8). Electronic transaction card interface 950 a compatible interface protocol for sleeve 900 to communicate through add-on slot 960.

Data routing circuitry 940 provides a communication path between IED interface 920 and electronic transaction card interface 950. In some embodiments, data routing circuitry 940 includes digital circuitry such as latches, buffers, multiplexers, and the like. Also in some embodiments, data routing circuitry 940 may include sequential circuitry such as state machines. Further, data routing circuitry 940 may include a processor such as a microprocessor, microcontroller, digital signal processor (DSP), or the like. Data routing circuitry 940 may be implemented as a separate block as shown in FIG. 9, or may be distributed between other blocks shown in FIG. 9. For example, data routing circuitry 940 may be distributed between IED interface 920 and electronic transaction card interface 950.

Power source 970 provides power for the circuit blocks shown in FIG. 9 in some embodiments, power source 970 includes a battery, such as battery 830 (FIG. 8). Also in some embodiments, power source 970 includes a charger port to couple an external charger to a battery, and in still further embodiments, power source 970 is omitted. In some embodiments, power for the various blocks shown in FIG. 9 is provided by an intelligent electronic device through mating connector 910.

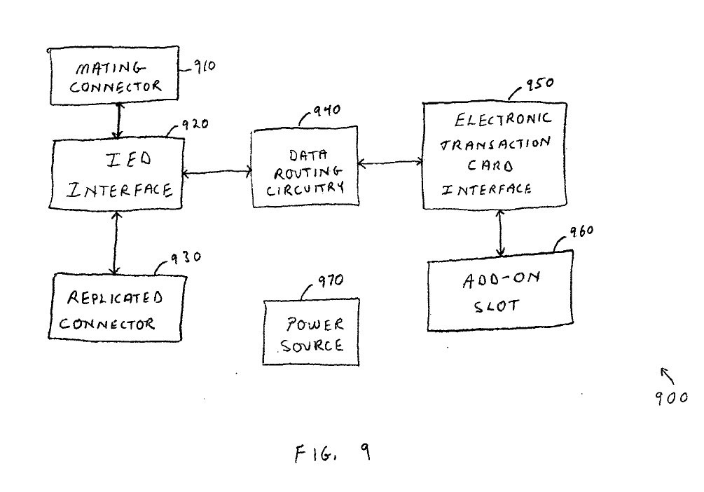

FIG. 10 shows a block diagram of a sleeve. Sleeve 1000 includes IED interface 920, replicated connector 930, data routing circuitry 940, electronic transaction card interface 950, add-on slot 960, and power source 970, which are described above with reference to FIG. 9. Sleeve 1000 also includes antenna 1020, and wireless interface 1010. Wireless interface 1010 is coupled to IED interface 920 to provide communication between sleeve 1000 and an intelligent electronic device. Accordingly, sleeve 1000 may be a sleeve with wireless capabilities, such as sleeve 320 (FIG. 3). Antenna 1020 may be any type of element capable of radiating energy and/or capturing energy.

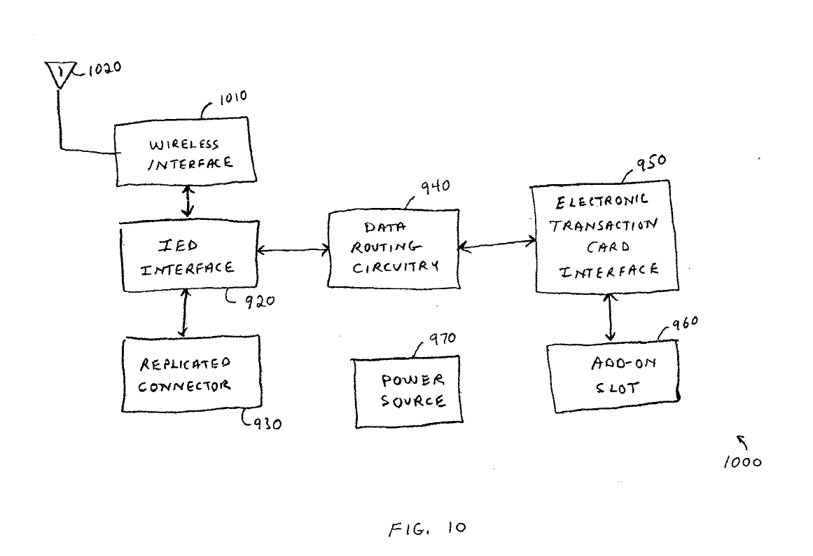

FIG. 11 shows a block diagram of a sleeve. Sleeve 1100 includes mating connector 910, IED interface 920, replicated connector 930, data routing circuitry 940, electronic transaction card interface 950, and power source 970, which are described above with reference to FIG. 9. Sleeve 1100 also includes antenna 1120, and wireless interface 1110. Wireless interface 1110 is coupled to electronic transaction card interface 960 to provide communication between sleeve 1100 and an electronic transaction card. Accordingly, sleeve 1100 may be a sleeve with wireless capabilities, such as sleeve 420 (FIG. 4). Antenna 1120 may be any type of element capable of radiating energy.

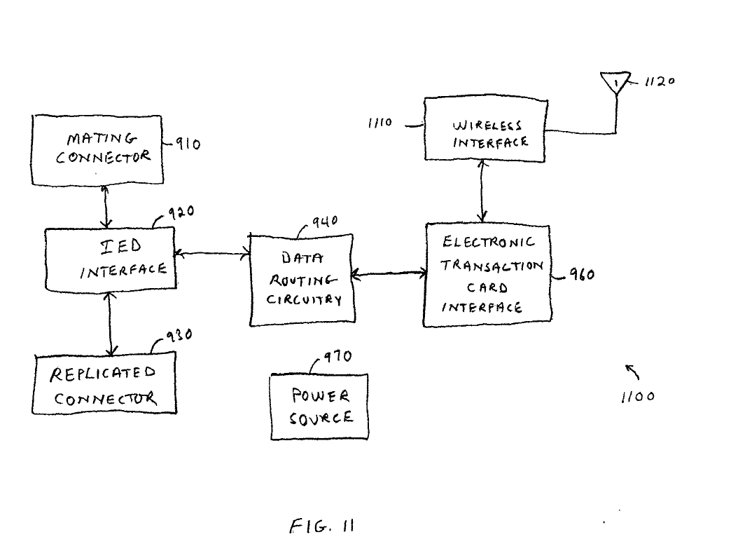

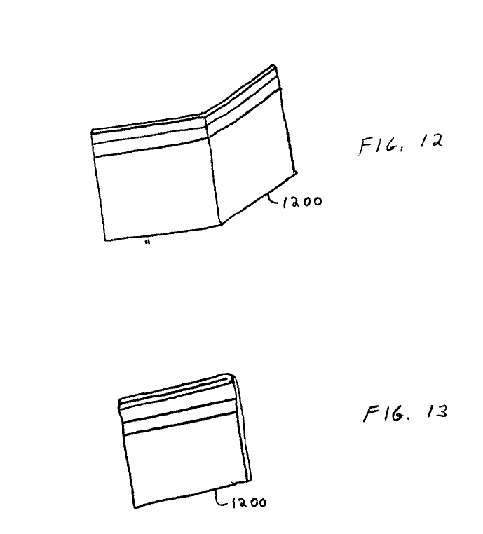

FIGS. 12 and 13 show a folding electronic transaction card. FIG. 12 shows electronic transaction card 1200 partially folded. Electronic transaction card 1200 may completely unfold to become flat. In some embodiments, electronic transaction card 120 unfolds to become the size of a standard credit card. Electronic transaction card 1200 may have electrical contacts or a wireless interface to communicate with a sleeve or an intelligent electronic device. FIG. 13 shows electronic transaction card 1200 folded. In some embodiments, electronic transaction card 1200 fits into an add-on slot of a sleeve when folded, and may be used either folded or unfolded in a transaction.

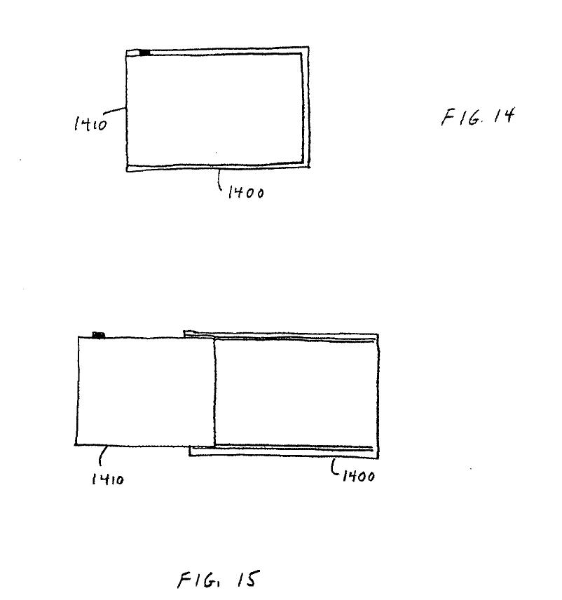

FIGS. 14 and 15 show an electronic transaction card having a sliding portion. FIG. 15 shows electronic transaction card 1400 with sliding portion 1410 “slid out,” and FIG. 14 shows sliding portion 1410 “slid in.” Electronic transaction card 1400 provides a variable form factor that allows the card to be smaller when used in an existing add-on slot, and larger for ease of use in a transaction.

FIGS. 12-15 show two different variable form factors for electronic transaction cards, but the invention is not so limited. For example, an electronic transaction card may have a pivot point, and a “larger” card may be created by rotating a portion of a card relative to another portion. Various embodiments of the present invention contemplate any variable form factor that allows a card to be a reduced size to be accepted by a slot, and an increased size for use in a transaction. Further, any variable form factor electronic transaction card may include a stripe, a smartcard interface, or both, on any portion of the card, and in any orientation without departing from the scope of the present invention.

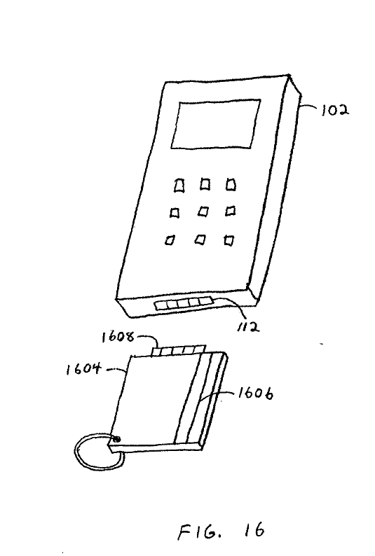

FIG. 16 shows an intelligent electronic device and an electronic transaction card. Intelligent electronic device 102 is described above with reference to previous figures. Electronic transaction card 1604 includes stripe 1606 and mating connector 1608. In operation, mating connector 1608 mates with connector 112 on intelligent electronic device 102. Electronic transaction card may then be removed from intelligent electronic device 102 and used in a magnetic card reader as shown in FIG. 6. In some embodiments, electronic transaction card 1604 includes a smartcard interface in lieu of, or in addition to, stripe 1606. Electronic transaction card 1604 may or may not have a hole for a key ring as shown in FIG. 16.

Although electronic transaction card 1604 is shown with mating connector 1608, this is not a limitation of the present invention. For example, electronic transaction card 1604 may include a contactless interface, such as a wireless interface, to communicate with intelligent electronic device 102.

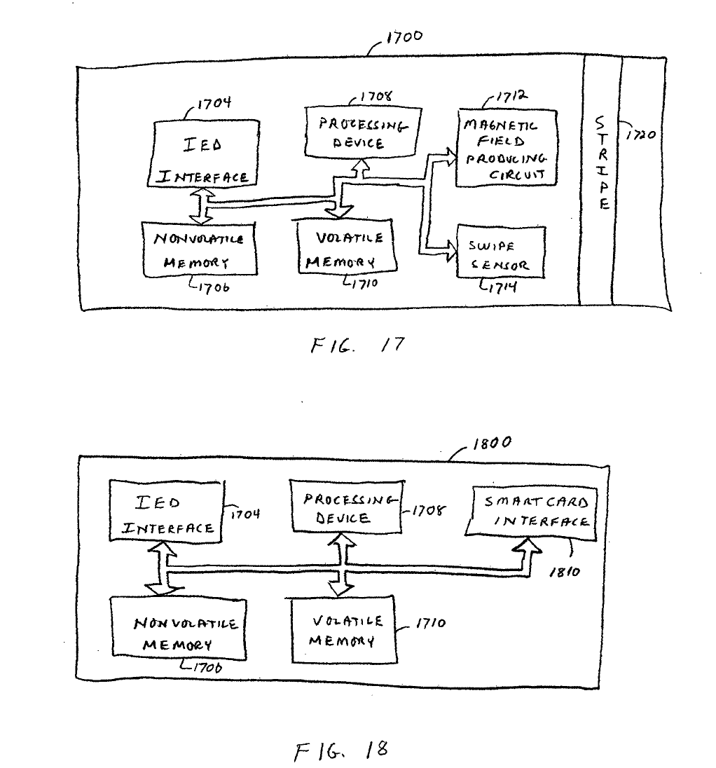

FIG. 17 shows a block diagram of an electronic transaction card. Electronic transaction card 1700 is an electronic transaction card capable of communicating with a sleeve, and capable of communicating with a magnetic card reader. For example, electronic transaction card 1700 may be any of the electronic transaction card embodiments described herein that includes a stripe.

Electronic transaction card 1700 includes intelligent electronic device (IED) interface 1704, nonvolatile memory 1706, processing device 1708, volatile memory 1710, magnetic field producing circuits 1712, swipe sensor 1714, and stripe 1720. IED interface 1704 is coupled to provide a communications interface between electronic transaction card 1700 and a sleeve or an intelligent electronic device. For example, IED interface 304 may be an interface compatible with an add-on slot, or may be a wireless interface that allows electronic transaction card 1700 to communicate wirelessly.

Magnetic field producing circuit 1712 includes one or more circuits to produce time-varying magnetic fields at or near the location of stripe 1720. For example, one or more current carrying conductors may be excited to produce a magnetic field, and the current may be varied in amplitude and reversed in polarity to cause the magnetic field to be time-varying. In some embodiments, the number of magnetic field producing circuits corresponds to the number of tracks being emulated for stripe 1720. For example, stripe 1720 may emulate two, three, four, or more magnetic tracks on a magnetic card such as a credit card. In these embodiments, electronic transaction card 1700 may include two, three, four, or more magnetic field producing circuits 1712. Magnetic field producing circuits 1712 may also include circuits to allow control of the time-varying magnetic field. For example, magnetic field producing circuits 1712 may include voltage drivers, current drivers, registers to hold digital data, sequential circuits to translate the digital data to magnetic fields, and the like.

Swipe sensor 1714 senses when electronic transaction card 1700 has been swiped in a magnetic card reader, and provides a swipe indication to processing device 1708. The swipe sensor may be a mechanical switch, an electronic switch, or any other type of suitable switch. For example, a mechanical switch may get pressed when electronic transaction card 1700 is swiped. Also for example, an electrical sensor may include two or more contacts (not shown) that get shorted when swiped past a metal head within a card reader. Further, a Hall effect sensor or light-based sensor may be utilized. The present invention is not limited by the type of swipe sensor utilized. In some embodiments, swipe sensor 1714 is omitted.

Processing device 1708 represents a processor capable of communicating with the other blocks shown in electronic transaction card 1700. For example, processing device 1708 may be a microprocessor, a digital signal processor (DSP), a microcontroller, or the like. Further, processing device 1708 may be formed from state machines or other sequential logic. In operation, processing device 1708 may read instructions from volatile memory 1710 and/or nonvolatile memory 1706 and perform actions in response thereto. For example, processing device 1708 may execute program instructions that influence communications between electronic transaction card 1700 and an intelligent electronic device, or between electronic transaction card 1700 and a magnetic card reader.

Volatile memory 1710 represents memory that may lose its state when power is removed from electronic transaction card 1700. For example, volatile memory 1710 may be static random access memory (SRAM). Volatile memory 1708 may be utilized by processing device 1708 when executing programs. For example, a program may be copied into volatile memory 1708 prior to execution. Also for example, processing device 1708 may use volatile memory 1708 to store data during the execution of a program.

Nonvolatile memory 1706 represents memory that does not lose its state when power is removed from electronic transaction card 1700. Nonvolatile memory 1706 may be any suitable type of memory such as Flash memory with floating gate transistor memory cells. Examples include NOR Flash memory, NAND Flash memory, and multibit/cell Flash memory.

Nonvolatile memory 1706 may hold program instructions that are executable by processing device 1708. For example, prior to being sold, a manufacturer or distributor may program nonvolatile memory 1706 with program information to influence the operation of electronic transaction card 1700. Also for example, an intelligent electronic device or sleeve may provide program information to electronic transaction card 1700 through IED interface 1704.

Nonvolatile memory 1706 may also hold program instructions that are executable by a processing device other than processing device 1708. For example, a manufacturer, distributor, reseller, or other participant in the chain of commerce may program nonvolatile memory 1706 with program information to be transferred to an intelligent electronic device. Information to be transferred may include device drivers, application software, or the like.

Electronic transaction card 1700 may include one or more power sources (not shown). For example, electronic transaction card 1700 may include a battery or a capacitor such as a supercapacitor. In some embodiments, a rechargeable battery may be included. The rechargeable battery may accept a charge from an add-on slot in an intelligent electronic device. In some embodiments, a capacitor may accept a charge from an intelligent electronic device. The capacitor may provide power to electronic transaction card 1700 for enough time to perform a transaction. Further, the capacitor may be sized to ensure that a transaction may only be performed during a limited time period after removing the electronic transaction card from an add-on slot, thereby ensuring that a stolen card may not be used repeatedly without the cardholder's consent. Also in some embodiments, electronic transaction card 1700 may be programmed to go dormant if a transaction is not performed within a limited time period after removing the card from an intelligent electronic device.

Electronic transaction card 1700 may include one or more integrated circuits. For example, processing device 1708 may be on one integrated circuit die, and the memories may be on another integrated circuit die. In some embodiments, all active devices are included on a single integrated circuit die. In some embodiments, various integrated circuit dice are mounted on a common substrate to provide a high level of integration using separate dice. Any amount of circuit integration may be practiced without departing from the scope of the present invention.

FIG. 18 shows a block diagram of an electronic transaction card. Electronic transaction card 1800 includes IED interface 1704, nonvolatile memory 1706, processing device 1708, volatile memory 1710, and smartcard interface 1810. Electronic transaction card 1800 is similar to electronic transaction card 1700 (FIG. 17), with the exception of smartcard interface 1810. Smartcard interface 1810 allows electronic transaction card 1800 to be used in transactions with a smartcard reader.

Electronic transaction cards 1700 and 1800 may have any of the physical forms described herein. For example, either card may be compatible with a memory card, a credit card, a folding card, or any combination.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. An apparatus comprising:
a body portion having a contour to receive an intelligent electronic device;
a first interface to provide communication with the intelligent electronic device; and
a second interface to provide communication with an electronic transaction card.

2. The apparatus of claim 1 wherein the first interface comprises a circuit to communicate with an add-on slot in the intelligent electronic device.

3. The apparatus of claim 2 wherein the add-on slot comprises a memory card slot.

4. The apparatus of claim 1 wherein the first interface comprises a wireless interface.

5. The apparatus of claim 1 wherein the first interface includes contacts to communicate with a data connector on the intelligent electronic device.

6. The apparatus of claim 5 further comprising a replicated data connector to replicate the data connector on the intelligent electronic device.

7. The apparatus of claim 1 wherein the contour is shaped to receive a cellular phone as the intelligent electronic device.

8. The apparatus of claim 1 wherein the contour is shaped to receive a personal digital assistant as the intelligent electronic device.

9. A sleeve to provide communications between a handheld intelligent electronic device and an electronic transaction card, the sleeve comprising:
an add-on slot to receive the electronic transaction card; and
an interface to communicate with the handheld intelligent electronic device.

10. The sleeve of claim 9 wherein the interface comprises a mating connector to couple to a connector on the handheld intelligent electronic device.

11. The sleeve of claim 10 wherein the sleeve further includes a replicated connector to replicate the connector on the handheld intelligent electronic device.

12. The sleeve of claim 9 wherein the add-on slot comprises a memory card slot.

13. The sleeve of claim 9 wherein the interface comprises a wireless interface.

14. The sleeve of claim 9 further comprising a battery.

15. An apparatus comprising:
means for communicating with an intelligent electronic device;
means for receiving an electronic transaction card; and
means for communicating with the electronic transaction card.

16. The apparatus of claim 15 wherein the means for receiving an electronic transaction card comprises an add-on slot.

17. The apparatus of claim 15 wherein the means for communicating with the electronic transaction card comprises a memory card compatible interface.

18. The apparatus of claim 15 wherein means for communicating with an intelligent electronic device comprises a mating connector to mate with a connector on the intelligent electronic device.

19. The apparatus of claim 18 further comprising a replicated connector to replicate the connector on the intelligent electronic device.

20. A transaction system comprising:
a cellular phone receiving portion having a shape compatible with a cellular phone and having an interface to communicate with the cellular phone; and
a stripe to communicate with a magnetic card reader.

21. The transaction system of claim 20 wherein the transaction system includes an electronic transaction card upon which the stripe is located.

22. The transaction system of claim 21 wherein the transaction system includes a sleeve upon which the cellular phone receiving portion is located.

23. The transaction system of claim 22 wherein the sleeve includes an add-on slot to receive the electronic transaction card.

24. The transaction system of claim 20 wherein the electronic transaction card includes a foldable portion to reduce the size of the electronic transaction card when folded.

25. The transaction system of claim 20 further comprising circuitry to produce a time-varying magnetic field in a vicinity of the stripe.
